(19) United States
(12) Patent Application Publication
(10) Pub. No.: US 2025/0121478 A1
(43) Pub. Date: Apr. 17, 2025

(54) ELECTRIC TOOL

(71) Applicant: Panasonic Holdings Corporation, Osaka (JP)

(72) Inventor: Kotaro MOMOEDA, Osaka (JP)

(73) Assignee: Panasonic Holdings Corporation, Osaka (JP)

(21) Appl. No.: 18/685,215

(22) PCT Filed: Mar. 18, 2022
(86) PCT No.: PCT/JP2022/012657

§ 371 Date: Feb. 20, 2024

(30) Foreign Application Priority Data
Sep. 2, 2021 (JP) 2021-143484

(51) Int. Cl. B25B 21/00; B25B 23/14; B25B 23/147

(52) U.S. Cl. CPC B25B 21/00; B25B 23/141; B25B 23/147

(57) ABSTRACT

An electric tool according to the present disclosure includes a motor, a holding member, a transmission mechanism, a torque detection unit, a control unit, and a clutch mechanism. The holding member holds a tip tool thereon. The transmission mechanism transmits torque of the motor to the holding member. The torque detection unit detects the torque transmitted from the motor to the holding member. The control unit stops running the motor when the torque detected by the torque detection unit reaches first preset torque). The clutch mechanism switches, when the torque transmitted from the motor to the holding member reaches second preset torque, from a transmitting state where the torque of the motor is transmitted to the holding member to a cutoff state where transmission of the torque of the motor to the holding member is cut off.

### TECHNICAL FIELD

The present disclosure generally relates to an electric tool, and more particularly relates to an electric tool including a clutch mechanism.

### BACKGROUND ART

Patent Literature 1 discloses an electric rotary tool (electric tool) including a motor unit (motor) and a control circuit section for controlling the motor unit. The control circuit section calculates fastening torque based on either a drive current for the motor unit which has been detected by a current detecting means or the number of revolutions of the motor unit which has been detected by a number of revolutions detecting means. When finding the fastening torque thus calculated equal to or greater than preset fastening torque, the control circuit section stops running the motor unit.

In the electric tool 1 of Patent Literature 1, however, in a situation where a holding member that holds a tip tool thereon has significant inertial force, the motor will continue running for a while due to the inertial force of the holding member, even after the motor has been controlled to stop running, thus taking some time to bring the motor to a halt. This causes an increase in fastening torque so significantly that a fastening member such as a bolt or a nut could be fastened with fastening torque greater than the preset one.

### CITATION LIST

### Patent Literature

Patent Literature 1: JP 2009-202317 A

### SUMMARY OF INVENTION

In view of the foregoing background, it is therefore an object of the present disclosure to provide an electric tool that may reduce the chances of fastening a fastening member excessively. An electric tool according to an aspect of the present disclosure includes a motor, a holding member, a transmission mechanism, a torque detection unit, a control unit, and a clutch mechanism. The holding member holds a tip tool thereon. The transmission mechanism transmits torque of the motor to the holding member. The torque detection unit detects the torque transmitted from the motor to the holding member. The control unit stops running the motor when the torque detected by the torque detection unit reaches first preset torque. The clutch mechanism switches, when the torque transmitted from the motor to the holding member reaches second preset torque, from a transmitting state where the torque of the motor is transmitted to the holding member to a cutoff state where transmission of the torque of the motor to the holding member is cut off.

### BRIEF DESCRIPTION OF DRAWINGS

FIG. 1 is a schematic representation of an electric tool according to an exemplary embodiment;

FIG. 2 is a graph showing a relationship between a torque level, a first preset torque, a second preset torque, and supposed fastening torque in a situation where the electric tool is in a low-speed rotational state; and

FIG. 3 is a graph showing a relationship between the torque level, the first preset torque, the second preset torque, and the supposed fastening torque in a situation where the electric tool is in a high-speed rotational state.

### DESCRIPTION OF EMBODIMENTS

An electric tool 1 according to an exemplary embodiment of the present disclosure will now be described in detail with reference to the accompanying drawings. Note that the drawings to be referred to in the following description of embodiments are all schematic representations. Thus, the ratio of the dimensions (including thicknesses) of respective constituent elements illustrated on the drawings does not always reflect their actual dimensional ratio. Note that the exemplary embodiments and their variations to be described below are only examples of the present disclosure and should not be construed as limiting. Rather, the exemplary embodiments and their variations may be readily modified in various manners depending on a design choice or any other factor without departing from a true spirit and scope of the present disclosure. Optionally, the exemplary embodiments and their variations to be described below may be adopted as appropriate in combination.

### (1) Overview

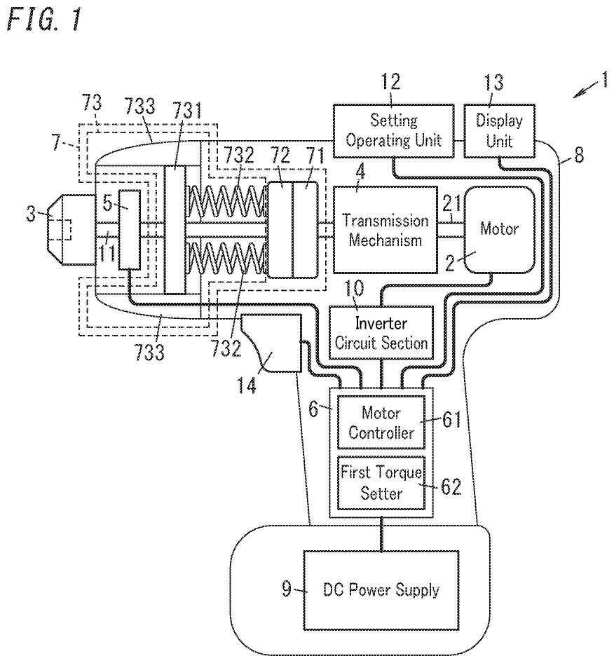

First, an overview of an electric tool 1 according to an exemplary embodiment will be described with reference to FIG. 1.

The electric tool 1 according to this embodiment is designed to be able to fasten a fastening member such as a screw or a bolt with torque at any selected level.

The electric tool 1 includes a motor 2, a holding member 3, a transmission mechanism 4, a torque detection unit 5, a control unit 6, and a clutch mechanism 7.

The motor 2 is an electric motor.

The holding member 3 holds a tip tool thereon.

The transmission mechanism 4 is interposed between the motor 2 and the holding member 3 to transmit the torque of the motor 2 to the holding member 3.

The torque detection unit 5 detects the torque transmitted from the motor 2 to the holding member 3.

The control unit 6 stops running the motor 2 when the torque detected by the torque detection unit 5 reaches first preset torque T1.

The clutch mechanism 7 switches, when the torque transmitted from the motor 2 to the holding member 3 reaches second preset torque T2, from a transmitting state where the torque of the motor 2 is transmitted to the holding member 3 to a cutoff state where transmission of the torque of the motor 2 to the holding member 3 is cut off.

This configuration allows, if the inertial force of the holding member 3 is weak enough to bring the holding member 3 to a halt when the motor 2 is controlled to stop running, the torque of fastening the fastening member (i.e., fastening torque) to be controlled at the first preset torque T1 by making the control unit 6 control the motor 2 to stop running. This configuration also allows, if the inertial force of the holding member 3 is strong enough to keep the holding member 3 turning even when the motor 2 is controlled to stop running, the fastening torque to be controlled at the second preset torque T2 by causing the clutch mechanism 7 to switch from the transmitting state to the cutoff state. Consequently, this configuration may reduce the chances of fastening the fastening member excessively.

### (2) Details

Next, the electric tool 1 according to this embodiment will be described in further detail.

### (2.1) Configuration for Electric Tool

A configuration for the electric tool 1 will now be described with reference to FIG. 1.

As shown in FIG. 1, the electric tool 1 includes a housing 8, the motor 2, a DC power supply 9, an inverter circuit section 10, an output shaft 11, the holding member 3, the transmission mechanism 4, the torque detection unit 5, the clutch mechanism 7, the control unit 6, a setting operating unit 12, a display unit 13, and an operating member 14.

The housing 8 houses or holds the motor 2, the inverter circuit section 10, a part of the output shaft 11, the transmission mechanism 4, the torque detection unit 5, the clutch mechanism 7, and the control unit 6.

The motor 2 may be a brushless motor, for example. The motor 2 includes a rotor having a permanent magnet and a stator having a motor coil. The rotor further includes a rotary shaft 21 that outputs torque. The rotor rotates with respect to the stator due to electromagnetic interaction between the motor coil and the permanent magnet.

The DC power supply 9 is a power supply for use to drive the motor 2. In this embodiment, the DC power supply 9 includes a secondary battery. The DC power supply 9 is a so-called “battery pack.” The DC power supply 9 may also be used as a power supply for the inverter circuit section 10 and the control unit 6.

The inverter circuit section 10 is a circuit for driving the motor 2. The inverter circuit section 10 converts the DC voltage supplied from the DC power supply 9 into drive voltage for driving the motor 2. In this embodiment, the drive voltage may be, for example, three-phase AC voltage.

The output shaft 11 is a part designed to be rotated by the torque of the motor 2. A tip tool such as a screwdriver bit or a drill bit is attached to the output shaft 11 via the holding member 3.

The transmission mechanism 4 is interposed between the motor 2 and the holding member 3. The transmission mechanism 4 transmits the torque of the motor 2 to the holding member 3 via the output shaft 11. More specifically, the transmission mechanism 4 reduces the rotational velocity of the rotary shaft 21 of the motor 2 and then transmits the rotational torque of the rotary shaft 21 with the reduced velocity to the holding member 3 via the output shaft 11. In this embodiment, the clutch mechanism 7 is provided between the transmission mechanism 4 and the output shaft 11 and the transmission mechanism 4 transmits the torque of the motor 2 to the holding member 3 via the clutch mechanism 7 and the output shaft 11.

The torque detection unit 5 detects the torque (fastening torque) transmitted from the motor 2 to the holding member 3 via the output shaft 11. In this embodiment, the torque detection unit 5 may include, for example, a magnetostrictive strain sensor. The magnetostrictive strain sensor detects a variation in permeability, reflecting the strain produced by the application of the torque to the output shaft 11, using, for example, a coil (not shown) installed in the housing 8 and outputs a voltage signal proportional to the strain to the control unit 6.

The clutch mechanism 7 is interposed between the transmission mechanism 4 and the holding member 3. The clutch mechanism 7 switches, when the fastening torque transmitted from the motor 2 to the holding member 3 reaches preset torque (i.e., second preset torque T2), from a transmitting state where the torque of the motor is transmitted to the holding member 3 to a cutoff state where transmission of the torque of the motor 2 to the holding member 3 is cut off.

Next, the configuration and operation of the clutch mechanism 7 will be described.

The clutch mechanism 7 includes a first driving force transmission member 71, a second driving force transmission member 72, and a second torque setter 73. The second torque setter 73 includes a movable member 731, a clutch spring 732, and a clutch handle 733.

The first driving force transmission member 71 is connected to the rotary shaft 21 of the motor 2 via the transmission mechanism 4. The second driving force transmission member 72 is connected to the output shaft 11. In addition, the second driving force transmission member 72 is also coupled to one end of the clutch spring 732 and the movable member 731 is coupled to the other end of the clutch spring 732.

Unless fastening torque equal to or greater than the second preset torque T2 is applied to the output shaft 11, the first driving force transmission member 71 is pressed against the second driving force transmission member 72 by the elastic force applied by the clutch spring 732, thus causing the first driving force transmission member 71 and the second driving force transmission member 72 to rotate together. At this time, the clutch mechanism 7 transmits the torque from the motor 2 to the holding member 3 (which is the transmitting state).

On the other hand, if fastening torque equal to or greater than the second preset torque T2 is applied to the output shaft 11, the second driving force transmission member 72 moves away from the first driving force transmission member 71 by overcoming the elastic force applied by the clutch spring 732. As a result, the first driving force transmission member 71 and the second driving force transmission member 72 are separated from each other. In this case, the clutch mechanism 7 does not transmit the torque from the motor 2 to the holding member 3 (which is the cutoff state).

The clutch handle 733 is a dial member which may be turned manually around the output shaft 11. The clutch handle 733 may be provided at the tip of the electric tool 1 (i.e., beside the holding member 3), for example, adjacent to the housing 8.

The movable member 731 may include, for example, a screw mechanism and is configured to be displaced along the axis of the output shaft 11 by manually turning the clutch handle 733. Displacing the movable member 731 toward the second driving force transmission member 72 causes the clutch spring 732 to be pressed and compressed by the movable member 731, thus causing an increase in initial deflection. This causes the second driving force transmission member 72 to press the first driving force transmission member 71 with increasing force. Consequently, greater fastening torque is required to separate the first driving force transmission member 71 and the second driving force transmission member 72 from each other. That is to say, displacing the movable member 731 toward the second driving force transmission member 72 allows the second preset torque T2 to be increased. On the other hand, displacing the movable member 731 away from the second driving force transmission member 72 causes the clutch spring 732 to be stretched by the movable member 731, thus causing a decrease in initial deflection. This causes the second driving force transmission member 72 to press the first driving force transmission member 71 with decreasing force. Consequently, lesser fastening torque is required to separate the first driving force transmission member 71 and the second driving force transmission member 72 from each other. That is to say, displacing the movable member 731 away from the second driving force transmission member 72 allows the second preset torque T2 to be decreased. In this manner, the second torque setter 73 sets the value of the second preset torque T2 in accordance with the manual operation performed by the user on the clutch handle 733.

The second preset torque T2 may be changed stepwise by having the clutch handle 733 turned by the user of the electric tool 1 and switched to one of multiple positions after another stepwise. Specifically, the clutch handle 733 may have, for example, twenty-one graduations (torque level graduations), respectively representing twenty-one torque levels ST (namely, Levels 1 through 21), for example, along the circumference thereof. The Arabic numerals “1” through “21” are inscribed near the twenty-one graduations, respectively. The user of the electric tool 1 may turn the clutch handle 733 to align any one of these graduations with a single mark provided for the body of the housing 8 and thereby set the value of the second preset torque T2 at his or her desired torque level ST corresponding to the graduation selected by him or her.

In this case, the torque level ST of the second preset torque T2 corresponds to the stepwise position of the movable member 731 along the output shaft 11. That is to say, the respective torque levels ST correspond stepwise to the respective values of the second preset torque T2 that vary depending on how much the clutch spring 732 is stretched or compressed. In other words, as the torque level ST rises, the movable member 731 moves stepwise along the output shaft 11 closer and closer toward the second driving force transmission member 72, thus causing a stepwise increase in the second preset torque T2.

In this embodiment, the second preset torque T2 when the selected torque level ST is Level 1 may be about 0.3 N·m, while the second preset torque T2 when the selected torque level ST is Level 21 may be about 4.0 N·m.

The clutch handle 733 may have, for example, not only the twenty-one graduations but also one switch gradation as well. The switch gradation is a gradation to be used in a situation where the fastening torque control is performed only by controlling the motor 2 using the control unit 6. A circular mark, for example, may be inscribed near the switch gradation. It will be described later in the “(2.2) Fastening torque control operation” section how to use the switch gradation.

The second torque setter 73 further includes a displacement sensor (not shown). The displacement sensor detects the circumferential displacement of the clutch handle 733 that has been turned by the user and outputs, based on the result of detection, information including the currently selected torque level ST, to the control unit 6. Note that this configuration of the clutch mechanism 7 should not be construed as limiting but may be changed as appropriate.

The control unit 6 is implemented as a computer system including one or more processors and a memory. The computer system is allowed to perform the functions of the control unit 6 by making the one or more processors execute a program stored in the memory. In this embodiment, the program is stored in advance in the memory of the control unit 6. Alternatively, the program may also be downloaded via a telecommunications line such as the Internet or distributed after having been stored in a non-transitory storage medium such as a memory card. The control unit 6 may also be implemented as, for example, a field-programmable gate array (FPGA) or an application specific integrated circuit (ASIC).

The control unit 6 includes a motor controller 61 and the first torque setter 62. Note that the motor controller 61 and the first torque setter 62 do not necessarily have a substantive physical configuration but just represent respective functions to be performed by the control unit 6.

The motor controller 61 controls the operation of the motor 2 by regulating the drive voltage supplied from the inverter circuit section 10 to the motor 2.

The motor controller 61 determines, based on a voltage signal supplied from the torque detection unit 5, the value of the fastening torque. The motor controller 61 stops running the motor 2 when the fastening torque reaches preset torque (i.e., the first preset torque T1).

The first torque setter 62 sets the value of the first preset torque T1 based on the current value of the second preset torque T2 corresponding to any one of Levels 1-21. Specifically, the first torque setter 62 determines the current value of the second preset torque T2 in accordance with the information provided by the displacement sensor of the second torque setter 73 and including the selected torque level ST. More specifically, the first torque setter 62 sets, based on the current value of the second preset torque T2, the value of the first preset torque T1 at a value which is smaller by a few percent, for example, than the current value of the second preset torque T2. The first preset torque T1, as well as the second preset torque T2, may also have its value set stepwise, based on the current value of the second preset torque T2, at a value corresponding to a selected torque level ST which is any one of Levels 1-21.

In addition, the first torque setter 62 outputs information including the torque level ST to the display unit 13.

The display unit 13 may include, for example, two sets of seven-segment light-emitting diodes (LEDs) representing two digits, respectively. The display unit 13 displays, in accordance with the information including the torque level ST, a torque level ST that has been currently selected (e.g., any one of the twenty-one Arabic numerals “01” through “21”). Alternatively, the display unit 13 may also display the current value of the second preset torque T2.

The display unit 13 is provided to be exposed on the upper part of the housing 8 and is configured to allow the user of the electric tool 1 to recognize the Arabic numeral displayed by the two sets of seven-segment LEDs to indicate the currently selected torque level ST.

The setting operating unit 12 is used to manually set the value of the first preset torque T1 in a situation where the fastening torque control is performed only by controlling the running of the motor 2 using the control unit 6. The setting operating unit 12 may include, for example, a switch to be pressed to increase the value of the first preset torque T1 (i.e., a plus (+) switch) and a switch to be pressed to decrease the value of the first preset torque T1 (i.e., a minus (−) switch). The setting operating unit 12 is provided to be exposed on the upper part of the housing 8 and configured to accept the press operation performed by the user of the electric tool 1. As will be described in detail later in the “(2.2) Fastening torque control operation” section, the setting operating unit 12 may change the value of the first preset torque T1 stepwise in such a situation where the fastening torque control is performed only by controlling the running of the motor 2 using the control unit 6. In this case, the value of the first preset torque T1 to be changed stepwise is set at a value larger than the current value of the second preset torque T2 corresponding to the selected torque level ST that is any one of Levels 1-21. The value of the first preset torque T1 may correspond to a torque level ST that is any one of nine levels (namely, Levels 22-30), for example.

The display unit 13 further displays the torque level ST (which may be any one of the nine Arabic numerals “22” through “30”) of the first preset torque T1, of which the value has been set in the situation where the fastening torque control is performed only by controlling the motor 2 using the control unit 6.

The operating member 14 accepts the operation for controlling the rotation of the motor 2. The operating member 14 may be, for example, a trigger switch provided for the grip part of the housing 8. The motor 2 may be selectively turned ON and OFF by performing the operation of pulling the operating member 14. In addition, the rotational velocity of the motor 2 may also be adjusted by the manipulative variable of the operating member 14 (i.e., depending on how deep the operating member 14 is pulled). The larger the manipulative variable is, the higher the rotational velocity of the motor 2 becomes. The motor controller 61 starts or stops running the motor 2, and controls the rotational velocity of the motor 2, according to the manipulative variable of the operation of pulling the operating member 14.

### (2.2) Fastening Torque Control Operation

Next, it will be described with reference to FIGS. 1-3 how the electric tool 1 performs the fastening torque control operation to prevent the fastening member from being fastened excessively.

The fastening torque control operation is performed in a different manner according to the rotational state (or the number of revolutions) of the motor 2. The following description will be focused, as an example, on a “high-speed rotational state” where the number of revolutions of the motor 2 is relatively large and on a “low-speed rotational state” where the number of revolutions of the motor 2 is relatively small. Note that the “high-speed rotational state” and the “low-speed rotational state” will be defined later when it is described how the fastening torque control operation is performed in each of these rotational states.

### (2.2.1) Fastening Torque Control Operation in Low-Speed Rotational State

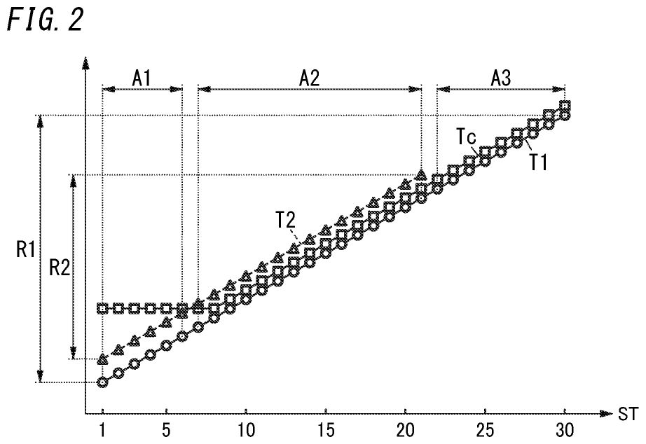

FIG. 2 shows an exemplary relationship between the selected torque level ST of the electric tool 1, the first preset torque T1, the second preset torque T2, and supposed fastening torque Tc in the low-speed rotational state. In FIG. 2, the abscissa indicates the selected torque level ST, and the ordinate indicates the respective values of the first preset torque T1, the second preset torque T2, and the supposed fastening torque Tc. As used herein, the supposed fastening torque Tc refers to the fastening torque to be applied to the fastening member on the supposition that the fastening torque control operation is performed only by controlling the running of the motor 2 using the motor controller 61 without controlling the fastening torque using the clutch mechanism 7. Also, the “low-speed rotational state” as used herein refers to a state where the supposed fastening torque Tc is made greater than the first preset torque T1 by the inertial force of the holding member 3 in a range where the selected torque level ST falls within the range from Level 1 through Level 6 (hereinafter referred to as a “first torque range A1”) and where the supposed fastening torque Tc is controlled at a value approximately equal to the value of the first preset torque T1 in a range where the selected torque level ST falls within the range from Level 7 through Level 21 (hereinafter referred to as a “second torque range A2”). Note that the rotational state of the motor 2 may also be state other than the “low-speed rotational state” and the “high-speed rotational state” to be described later in the “(2.2.2) Fastening torque control operation in high-speed rotational state” section. That is to say, the “low-speed rotational state” and the “high-speed rotational state” are only exemplary rotational states of the motor 2.

First, in the first torque range A1, even after the motor controller 61 has stopped running the motor 2, the supposed fastening torque Tc continues to increase as shown in FIG. 2 due to the inertial force of the holding member 3 to exceed the first preset torque T1 as described above.

When the electric tool 1 actually performs the fastening torque control in the low-speed rotational state, the fastening torque reaches the second preset torque T2 due to the inertial force of the holding member 3 after having reached the first preset torque T1 to cause the motor 2 to stop running. In this embodiment, the setting value of the first preset torque T1 is lower by a few percent than the setting value of the second preset torque T2 as described above. Thereafter, when the fastening torque reaches the second preset torque T2, the clutch mechanism 7 switches from the transmitting state to the cutoff state, thus reducing an increase in the fastening torque. That is to say, in the first torque range A1, the maximum value of the fastening torque applied to the fastening member is the setting value of the second preset torque T2.

On the other hand, in the second torque range A2, the supposed fastening torque Tc is controlled at a value approximately equal to that of the first preset torque T1 as described above. That is to say, when the fastening torque control is performed in the low-speed rotational state, after the fastening torque has reached the first preset torque T1 to cause the motor 2 to stop running, the inertial force of the holding member 3 is lost and the maximum value of the fastening torque becomes a value approximately equal to the value of the first preset torque T1. Also, even in a rotational state where the supposed fastening torque Tc is greater than the first preset torque T1 in the second torque range A2 as in the high-speed rotational state to be described below in the “(2.2.2) Fastening torque control operation in high-speed rotational state” section, the increase in fastening torque is reduced by the clutch mechanism 7 in the actual fastening torque control once the fastening torque has reached the second preset torque T2.

In a range where the selected torque level ST falls within the range from Levels 22-30, for example (i.e., in a third torque range A3), the value of the second preset torque T2 is not set but only the value of the first preset torque T1 is set.

When the selected torque level ST falls within the range from Level 1 to Level 21, the clutch spring 732 is compressed by turning the clutch handle 733, thus setting the value of the second preset torque T2. In addition, the first torque setter 62 sets the value of the first preset torque T1 based on the value of the second preset torque T2 corresponding to any one of Levels 1-21. Nevertheless, the clutch spring 732 cannot be compressed to beyond a certain limit, and therefore, the setting value of the second preset torque T2 cannot be greater than the value corresponding to Level 21 as the selected torque level ST. That is to say, the clutch mechanism 7 is configured to prevent the movable member 731 from being displaced toward the second driving force transmission member 72 beyond the position when the torque level ST selected is Level 21.

In the third torque range A3, the setting value of the first preset torque T1 is larger than that of the second preset torque T2 corresponding to Level 21 as the selected torque level ST, and the fastening torque is controlled only by stopping running the motor 2 using the motor controller 61.

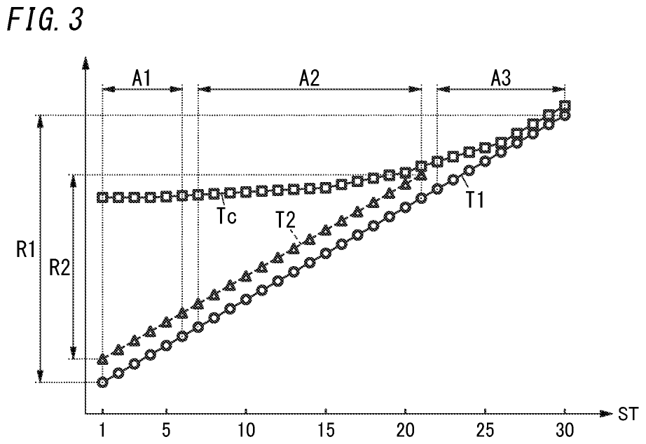

This configuration allows the value of the first preset torque T1 to be set within a first setting range R1 in each of the first to third torque ranges A1-A3, allows the value of the second preset torque T2 to be set within a second setting range R2 in each of the first torque range A1 and the second torque range A2, and makes the upper limit value of the first setting range R1 larger than the upper limit value of the second setting range R2 as shown in FIGS. 2 and 3.

Next, it will be described how to set the value of the first preset torque T1 in the third torque range A3.

If the user of the electric tool 1 wants to select a torque level ST equal to or greater than Level 22, he or she turns the clutch handle 733 to align the switch gradation provided circumferentially adjacent to the gradation corresponding to Level 21, for example, with a mark provided for the body of the housing 8. Then, the movable member 731 and the second driving force transmission member 72 are connected to each other via, for example, a metallic bar member (not shown) which is neither stretchable nor shrinkable, thus keeping the gap distance between the movable member 731 and the second driving force transmission member 72 constant. This allows the first driving force transmission member 71 and the second driving force transmission member 72 to always rotate together irrespective of the magnitude of the fastening torque. That is to say, the clutch mechanism 7 is maintained in the transmitting state irrespective of the magnitude of the fastening torque.

When the displacement sensor detects that the switch gradation has been aligned with the mark on the body and transmits a detection signal to the first torque setter 62, the first torque setter 62 is allowed to set the value of the first preset torque T1 corresponding to a torque level ST that is any one of Levels 22-30.

The user presses the plus and minus switches of the setting operating unit 12 with the switch gradation aligned with the mark on the body, thereby changing the torque level ST into his or her desired level falling within the range from Level 22 to Level 30. The currently selected torque level ST is displayed on the display unit 13, which allows the user to change the torque level ST while checking the information on the display unit 13. Note that if the currently selected torque level ST is Level 22, then the electric tool 1 does not accept the operation of pressing the minus switch of the setting operating unit 12. That is to say, the electric tool 1 is configured to prevent the user from setting the torque level ST at any level lower than Level 22 by operating the setting operating unit 12.

The first torque setter 62 sets the value of the first preset torque T1 corresponding to the torque level ST that is any one of Level 22 through Level 30 which has been selected by the user by operating the setting operating unit 12.

In the third torque range A3, once the fastening torque has reached the first preset torque T1 to cause the motor 2 to stop running, the inertial force of the holding member 3 is lost to make the maximum value of the fastening torque approximately equal to the first preset torque T1.

### (2.2.2) Fastening Torque Control Operation in High-Speed Rotational State

FIG. 3 shows an exemplary relationship between the selected torque level ST of the electric tool 1, the first preset torque T1, the second preset torque T2, and the supposed fastening torque Tc in the high-speed rotational state. As used herein, the “high-speed rotational state” refers to, for example, a state where the supposed fastening torque Tc is made greater than the first preset torque T1 in the first torque range Al and the second torque range A2. That is to say, the “high-speed rotational state” is a state where the inertial force of the holding member 3 is greater than in the “low-speed rotational state.” In the high-speed rotational state, the holding member 3 continues to turn in the first torque range A1 and the second torque range A2 even after the motor 2 has stopped running, thus making the supposed fastening torque Tc greater than the first preset torque T1.

First, in the first torque range A1, even after the motor controller 61 has stopped running the motor 2, the supposed fastening torque Tc continues to increase due to the inertial force of the holding member 3 to reach far beyond the first preset torque T1 as described above for the low-speed rotational state and as shown in FIG. 3.

When the electric tool 1 actually performs the fastening torque control in the high-speed rotational state, the fastening torque reaches the second preset torque T2 due to the inertial force of the holding member 3 after having reached the first preset torque T1 to cause the motor 2 to stop running. Thereafter, when the fastening torque reaches the second preset torque T2, the clutch mechanism 7 switches from the transmitting state to the cutoff state, thus reducing an increase in the fastening torque. That is to say, in the first torque range A1, the maximum value of the fastening torque applied to the fastening member is the setting value of the second preset torque T2.

In addition, in the second torque range A2, even after the motor 2 has stopped running, the supposed fastening torque Tc continues to increase due to the inertial force of the holding member 3 to exceed the first preset torque T1.

According to the fastening torque control performed in the high-speed rotational state by the electric tool 1 of this embodiment, after having reached the first preset torque T1 to cause the motor 2 to stop running, the fastening torque reaches the second preset torque T2 due to the inertial force of the holding member 3. When the fastening torque reaches the second preset torque T2, the clutch mechanism 7 switches from the transmitting state to the cutoff state, thus reducing an increase in the fastening torque. That is to say, in the second torque range A2, the maximum value of the fastening torque applied to the fastening member is equal to the setting value of the second preset torque T2.

In the third torque range A3, once the fastening torque has reached the first preset torque T1 to cause the motor 2 to stop running, the inertial force of the holding member 3 is lost to make the maximum value of the fastening torque approximately equal to the first preset torque T1.

### (3) Variations

Next, variations of the exemplary embodiment will be enumerated one after another. Note that the variations to be described below may be adopted in combination as appropriate.

The control unit 6 of the electric tool 1 according to the present disclosure includes a computer system. The computer system may include a processor and a memory as principal hardware components thereof. The functions of the control unit 6 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the control unit 6 are aggregated together in the single housing 8. However, this configuration is only an example and is not an essential configuration. Alternatively, the first torque setter 62 of the control unit 6, for example, may be implemented as a cloud computing system as well.

Furthermore, in the foregoing description, if one of two values being compared with each other is “equal to or greater than” the other, this phrase may also be a synonym of the phrase “greater than.” That is to say, it is arbitrarily changeable, depending on selection of a reference value or any preset value, whether or not the phrase “equal to or greater than” covers the situation where the two values are equal to each other. Therefore, from a technical point of view, there is no difference between the phrase “equal to or greater than” and the phrase “greater than.” Similarly, the phrase “equal to or less than” may be a synonym of the phrase “less than” as well. That is to say, from a technical point of view, there is no difference between the phrase “equal to or less than” and the phrase “less than.”

The motor 2 does not have to be a brushless motor but may also be a brush motor.

The holding member 3 may be formed integrally with a part of the transmission mechanism 4.

The tip tool may be counted out of the constituent elements of the electric tool 1.

The DC power supply 9 may also be counted out of the constituent elements of the electric tool 1.

The clutch mechanism 7 does not have to be disposed as described for the exemplary embodiment. Alternatively, the clutch mechanism 7 may also be interposed between the motor 2 and the transmission mechanism 4, for example.

The display unit 13 may also serve as the setting operating unit 12. In that case, the display unit 13 may include, for example, a touchscreen panel display that accepts touch operations by the user.

The torque detection unit 5 does not have to be a magnetostrictive strain sensor. Alternatively, the torque detection unit 5 may also be a resistive strain sensor, for example. The resistive strain sensor is affixed to the surface of the output shaft 11. The resistive strain sensor measures the strain of the output shaft 11. That is to say, the resistive strain sensor transforms an electrical resistance value, representing the strain produced by the application of the torque to the output shaft 11, into a voltage signal and outputs the voltage signal as the result of measurement.

The selected torque level ST does not have to be one of the thirty levels (i.e., Levels 1-30) but may also be one of twenty-nine or less levels or one of thirty-one or more levels. Also, the torque level ST that may be selected by turning the clutch handle 733 and thereby stretching or compressing the clutch spring 732 does not have to be one of the twenty-one levels but may also be one of twenty or less levels or one of twenty-two or more levels as far as the clutch spring 732 is stretchable or compressible.

### (4) Recapitulation

As can be seen from the foregoing description, an electric tool (1) according to a first aspect includes a motor (2), a holding member (3), a transmission mechanism (4), a torque detection unit (5), a control unit (6), and a clutch mechanism (7). The holding member (3) holds a tip tool thereon. The transmission mechanism (4) transmits torque of the motor (2) to the holding member (3). The torque detection unit (5) detects the torque transmitted from the motor (2) to the holding member (3). The control unit (6) stops running the motor (2) when the torque detected by the torque detection unit (5) reaches first preset torque (T1). The clutch mechanism (7) switches, when the torque transmitted from the motor (2) to the holding member (3) reaches second preset torque (T2), from a transmitting state where the torque of the motor (2) is transmitted to the holding member (3) to a cutoff state where transmission of the torque of the motor (2) to the holding member (3) is cut off.

This aspect allows, if the inertial force of the holding member (3) is weak enough to bring the holding member (3) to a halt when the motor (2) is controlled to stop running, the fastening torque to be controlled at the first preset torque (T1) by making the control unit (6) control the motor (2) to stop running. This aspect also allows, if the inertial force of the holding member (3) is strong enough to keep the holding member (3) turning even when the motor (2) is controlled to stop running, the fastening torque to be controlled at the second preset torque (T2) by causing the clutch mechanism (7) to switch from the transmitting state to the cutoff state. Consequently, this aspect may reduce the chances of fastening the fastening member excessively.

In an electric tool (1) according to a second aspect, which may be implemented in conjunction with the first aspect, the first preset torque (T1) has a value set within a first setting range (R1). The second preset torque (T2) has a value set within a second setting range (R2). An upper limit value of the first setting range (R1) is greater than an upper limit value of the second setting range (R2).

This aspect allows the fastening torque to be controlled by making the control unit (6) control the motor (2) in a range where the fastening torque is uncontrollable by the clutch mechanism (7).

An electric tool (1) according to a third aspect, which may be implemented in conjunction with the first or second aspect, further includes a second torque setter (73) and a first torque setter (62). The second torque setter (73) sets a value of the second preset torque (T2) in accordance with a manual operation performed by a user. The first torque setter (62) sets a value of the first preset torque (T1) based on the value of the second preset torque (T2).

This aspect allows the user to set the values of the second preset torque (T2) and the first preset torque (T1) at any desired values by performing a manual operation.

In an electric tool (1) according to a fourth aspect, which may be implemented in conjunction with any one of the first to third aspects, the first preset torque (T1) is set at a lower value than the second preset torque (T2).

This aspect allows, if the inertial force of the holding member (3) is weak enough to bring the holding member (3) to a halt when the motor (2) is controlled to stop running, the fastening torque to be controlled at the first preset torque (T1) by making the control unit (6) stop running the motor (2). This aspect also allows, if the inertial force of the holding member (3) is strong enough to keep the holding member (3) turning even when the motor (2) is controlled to stop running, the fastening torque to be controlled at the second preset torque (T2) by causing the clutch mechanism (7) to switch from the transmitting state to the cutoff state. Consequently, this aspect may reduce the chances of fastening the fastening member excessively.

Note that the constituent elements according to the second to fourth aspects are not essential constituent elements for the electric tool (1) but may be omitted as appropriate.

### Reference Signs List

1 Electric Tool

2 Motor

3 Holding Member

4 Transmission Mechanism

5 Torque Detection Unit

6 Control Unit

7 Clutch Mechanism

62 First Torque Setter

73 Second Torque Setter

R1 First Setting Range

R2 Second Setting Range

T1 First Preset Torque

T2 Second Preset Torque

1. An electric tool comprising:
a motor;
a holding member configured to hold a tip tool thereon;
a transmission mechanism configured to transmit torque of the motor to the holding member;
a torque detection unit configured to detect the torque transmitted from the motor to the holding member;
a control unit configured to stop running the motor when the torque detected by the torque detection unit reaches first preset torque; and
a clutch mechanism configured to switch, when the torque transmitted from the motor to the holding member reaches second preset torque, from a transmitting state where the torque of the motor is transmitted to the holding member to a cutoff state where transmission of the torque of the motor to the holding member is cut off.

2. The electric tool of claim 1, wherein
the first preset torque has a value set within a first setting range,
the second preset torque has a value set within a second setting range, and
an upper limit value of the first setting range is greater than an upper limit value of the second setting range.

3. The electric tool of claim 1, further comprising:
a second torque setter configured to set a value of the second preset torque in accordance with a manual operation performed by a user, and
a first torque setter configured to set a value of the first preset torque based on the value of the second preset torque.

4. The electric tool of claim 1, wherein
the first preset torque is set at a lower value than the second preset torque.

5. The electric tool of claim 2, further comprising:
a second torque setter configured to set a value of the second preset torque in accordance with a manual operation performed by a user, and
a first torque setter configured to set a value of the first preset torque based on the value of the second preset torque.

6. The electric tool of claim 2, wherein
the first preset torque is set at a lower value than the second preset torque.

7. The electric tool of claim 3, wherein
the first preset torque is set at a lower value than the second preset torque.
